(19) United States
(12) Patent Application Publication
(10) Pub. No.: US 2025/0337335 A1
(43) Pub. Date: Oct. 30, 2025

(54) POWER CONVERTER

(71) Applicants: Ayan MALLIK, Gilbert, AZ (US); Writtik DUTTA, Tempe, AZ (US); Naveed ISHRAQ, Tempe, AZ (US)

(72) Inventors: Ayan MALLIK, Gilbert, AZ (US); Writtik DUTTA, Tempe, AZ (US); Naveed ISHRAQ, Tempe, AZ (US)

(73) Assignee: Arizona Board of Regents on behalf of Arizona State University, Scottsdale, AZ (US)

(21) Appl. No.: 19/190,542

(22) Filed: Apr. 25, 2025

Related U.S. Application Data
(60) Provisional application No. 63/639,555, filed on Apr. 26, 2024.

(51) Int. Cl. H02M 3/335; H01F 27/28; H02M 1/00; H02M 3/00

(52) U.S. Cl. CPC H02M 3/33584; H01F 27/2804; H02M 1/0058; H02M 3/01; H01F 2027/2819

(57) ABSTRACT

A power converter. In some embodiments, the power converter includes: a low-voltage switching circuit including a first port of the power converter; a transformer, having: a first winding connected to the low-voltage switching circuit, and a second winding; and a high-voltage switching circuit including a second port of the power converter and being connected to the second winding, wherein: the power converter is capable, for a first set of control parameter values, of transmitting power from the first port to the second port, with an efficiency of at least 90%, the first port being at a first voltage and the second port being at a voltage at least 50 times the first voltage.

### CROSS-REFERENCE TO RELATED APPLICATION(S)

The present application claims priority to and the benefit of U.S. Provisional Application No. 63/639,555, filed Apr. 26, 2024, entitled “POWER CONVERTER”, the entire content of which is incorporated herein by reference.

### GOVERNMENT LICENSE RIGHTS

This invention was made with government support under DE-SC0024126 awarded by the Department of Energy. The government has certain rights in the invention.

### FIELD

One or more aspects of embodiments according to the present disclosure relate to power handling, and more particularly to a power converter

### BACKGROUND

The pursuit of sustainable electrical energy is integral to addressing the escalating global demand for energy while minimizing detrimental environmental effects. To achieve this goal, a diverse array of energy sources and storage devices are strategically employed in various applications, including centralized generation, small distributed networks, and system energy recovery. A diverse array of novel power generation and storage technologies, including thermoelectric generators, battery cells, fuel cells, and photovoltaic panels, predominantly produce power in direct current (dc) form. These systems typically function at relatively low voltage ranges, extending from a few millivolts to several volts. It is with respect to this general technical environment that aspects of the present disclosure are related.

### SUMMARY

According to an embodiment of the present disclosure, there is provided a system, including: a low-voltage switching circuit including a first port of the system; a transformer, having: a first winding connected to the low-voltage switching circuit, and a second winding; and a high-voltage switching circuit including a second port of the system and being connected to the second winding, wherein: the system is capable, for a first set of control parameter values, of transmitting power from the first port to the second port, with an efficiency of at least 90% (e.g., of at least 95%), the first port being at a first voltage and the second port being at a voltage at least 50 times the first voltage; and the system is capable, for a second set of control parameter values, of transmitting power from the second port to the first port, with an efficiency of at least 90% (e.g., of at least 95%), the first port being at a first voltage and the second port being at a voltage between 85 times the first voltage and 144 times the first voltage.

In some embodiments, the low-voltage switching circuit includes a circuit selected from the group consisting of half-bridge circuits and full-bridge circuits.

In some embodiments, the high-voltage switching circuit includes a circuit selected from the group consisting of half-bridge circuits, center-tapped circuits, and full-bridge circuits.

In some embodiments, the system includes an inductance-capacitance tank circuit including a resonant capacitor on a first side of the transformer, and a resonant inductor on a second side of the transformer, the second side being different from the first side.

In some embodiments, the resonant capacitor is on a low-voltage side of the transformer, and the resonant inductor is on a high-voltage side of the transformer.

In some embodiments, the system is capable of achieving a transmitted power density of at least 5 W per cubic inch.

In some embodiments, the transformer is a high frequency planar transformer formed on a multi-layer printed circuit board, wherein: a first layer of the multi-layer printed circuit board includes a turn of the second winding; a second layer of the multi-layer printed circuit board includes a turn of the first winding; a third layer of the multi-layer printed circuit board includes a turn of the second winding; and the second layer is between the first layer and the third layer.

In some embodiments, the transformer is a high frequency planar transformer formed on a six-layer printed circuit board with the following repetitive layer-stack: a first layer of the multi-layer printed circuit board includes a turn of the second winding; a second layer of the multi-layer printed circuit board includes multiple turns of the first winding; a third layer of the multi-layer printed circuit board includes a turn of the second winding; and the second layer is between the first layer and the third layer, thus making it a two-stack design.

In some embodiments, the second layer includes of 5 turns of the first winding.

In some embodiments, the second winding includes at least eight times as many turns as the first winding.

In some embodiments, a switch of the low-voltage switching circuit includes two semiconductor switches connected in parallel.

In some embodiments, the system further includes a switching control circuit configured: to cause a first switch, of the low-voltage switching circuit, to turn on when a voltage across the first switch is less than 1% of an off state blocking voltage; and to cause a second switch, of the high-voltage switching circuit, to turn on when a voltage across the second switch is less than 1% of an off state blocking voltage.

In some embodiments, the system is configured to operate over a range of switching frequencies extending from less than 350 kHz to more than 500 kHz.

According to an embodiment of the present disclosure, there is provided a system, including: a low-voltage switching circuit including a first port of the system; a transformer, having: a first winding connected to the low-voltage switching circuit, and a second winding; a high-voltage switching circuit including a second port of the system and being connected to the second winding; and an inductance-capacitance tank circuit including a resonant capacitor on a first side of the transformer, and a resonant inductor on a second side of the transformer, the second side being different from the first side.

In some embodiments, the resonant capacitor is on a low-voltage side of the transformer, and the resonant inductor is on a high-voltage side of the transformer.

In some embodiments, the low-voltage switching circuit includes a circuit selected from the group consisting of half-bridge circuits and full-bridge circuits.

In some embodiments, the high-voltage switching circuit includes a circuit selected from the group consisting of half-bridge circuits, center-tapped circuits, and full-bridge circuits.

In some embodiments, the system is capable of achieving a transmitted power density of at least 5 W per cubic inch.

In some embodiments, the transformer is a high frequency planar transformer formed on a multi-layer printed circuit board, wherein: a first layer of the multi-layer printed circuit board includes a turn of the second winding; a second layer of the multi-layer printed circuit board includes a turn of the first winding; a third layer of the multi-layer printed circuit board includes a turn of the second winding; and the second layer is between the first layer and the third layer.

In some embodiments, the second winding includes at least eight times as many turns as the first winding.

According to an embodiment of the present disclosure, there is provided a method, including: selecting a circuit parameter or control parameter for a dc-to-dc converter, the selecting including: calculating an operating current or an operating voltage for the dc-to-dc converter using an enhanced generalized harmonic approximation analysis.

In some embodiments: the dc-to-dc converter includes: a low-voltage switching circuit including a first port of the dc-to-dc converter; a transformer, having: a first winding connected to the low-voltage switching circuit, and a second winding; a high-voltage switching circuit including a second port of the dc-to-dc converter and being connected to the second winding; and an inductance-capacitance tank circuit including a resonant capacitor on a first side of the transformer, and a resonant inductor on a second side of the transformer; the method includes selecting a circuit parameter for the dc-to-dc converter; the circuit parameter is a parameter selected from the group consisting of the capacitance of the resonant capacitance, the inductance of the resonant inductor, the inductance of a magnetizing inductance of the transformer, the number of turns of the first winding, and the number of turns of the second winding; and the selecting includes optimizing an objective function subject to a constraint; the objective function is based on an efficiency of the dc-to-dc converter; and the constraint constrains the dc-to-dc converter to operate with zero-voltage switching.

In some embodiments, the method further includes calculating the efficiency based on conduction and switching losses, each for a plurality of values of voltage at the first port and averaged over a power transfer cycle.

In some embodiments: the method includes selecting an operating parameter for the dc-to-dc converter; and the operating parameter is a parameter selected from the group consisting of a switching frequency of the dc-to-dc converter, and an inter-bridge differential phase of the dc-to-dc converter.

In some embodiments, the calculating an operating current or an operating voltage for the dc-to-dc converter using an enhanced generalized harmonic approximation analysis includes calculating the operating current or the operating voltage taking account of the transformer inter-winding and intra-winding capacitances.

### BRIEF DESCRIPTION OF THE DRAWINGS

These and other features and advantages of the present disclosure will be appreciated and understood with reference to the specification, claims, and appended drawings wherein:

FIG. 1A is a schematic diagram of a power converter, according to an embodiment of the present disclosure;

FIG. 1B is a schematic diagram of a half-bridge circuit, according to an embodiment of the present disclosure;

FIG. 1C is a schematic diagram of a half-bridge circuit, according to an embodiment of the present disclosure;

FIG. 1D is a schematic diagram of a center-tapped circuit, according to an embodiment of the present disclosure;

FIG. 1E is a schematic diagram of a voltage-doubler circuit, according to an embodiment of the present disclosure;

FIG. 2 is a schematic diagram of an ac equivalent circuit, according to an embodiment of the present disclosure;

FIG. 3 is a schematic diagram of an ac equivalent circuit, according to an embodiment of the present disclosure;

FIG. 4 is a schematic diagram of an ac equivalent circuit, according to an embodiment of the present disclosure;

FIG. 5 is a schematic diagram of an ac equivalent circuit, according to an embodiment of the present disclosure;

FIG. 6 is a schematic diagram of a modified ac equivalent circuit, according to an embodiment of the present disclosure;

FIG. 7 is a schematic diagram of a simplified ac equivalent circuit, according to an embodiment of the present disclosure;

FIG. 8A is a schematic diagram illustrating contributions in an analysis based on linear superposition, according to an embodiment of the present disclosure;

FIG. 8B is a schematic diagram illustrating contributions in an analysis based on linear superposition, according to an embodiment of the present disclosure;

FIG. 8C is a table comparing the behavior of several models, according to an embodiment of the present disclosure;

FIG. 9A-9F are graphs of current waveforms, according to an embodiment of the present disclosure;

FIG. 10 is a schematic diagram of an equivalent Thevenin circuit model, according to an embodiment of the present disclosure;

FIG. 11A is a schematic diagram of an equivalent Thevenin circuit model, according to an embodiment of the present disclosure;

FIG. 11B is a schematic diagram of an equivalent Thevenin circuit model, according to an embodiment of the present disclosure;

FIG. 12 is a flow chart of an optimization process, according to an embodiment of the present disclosure;

FIG. 13 is a block diagram of a closed-loop controller, according to an embodiment of the present disclosure;

FIG. 14 is a flow diagram of a modeling and optimization process, according to an embodiment of the present disclosure;

FIG. 15A is a table of computation details by polynomial order, according to an embodiment of the present disclosure;

FIG. 15B is a table of coefficients, according to an embodiment of the present disclosure;

FIG. 15C is a table of values of parasitic components, according to an embodiment of the present disclosure;

FIG. 15D is a table of design specifications, according to an embodiment of the present disclosure;

FIG. 16A is a photograph of a reduction to practice, according to an embodiment of the present disclosure;

FIG. 16B depicts a layer of a printed circuit board, according to an embodiment of the present disclosure;

FIG. 16C depicts a layer of a printed circuit board, according to an embodiment of the present disclosure;

FIG. 16D depicts a layer of a printed circuit board, according to an embodiment of the present disclosure;

FIG. 16E depicts a layer of a printed circuit board, according to an embodiment of the present disclosure;

FIG. 16F depicts a layer of a printed circuit board, according to an embodiment of the present disclosure; and

FIG. 16G depicts a layer of a printed circuit board, according to an embodiment of the present disclosure.

### DETAILED DESCRIPTION

The detailed description set forth below in connection with the appended drawings is intended as a description of exemplary embodiments of a power converter provided in accordance with the present disclosure and is not intended to represent the only forms in which the present disclosure may be constructed or utilized. The description sets forth the features of the present disclosure in connection with the illustrated embodiments. It is to be understood, however, that the same or equivalent functions and structures may be accomplished by different embodiments that are also intended to be encompassed within the scope of the disclosure. As denoted elsewhere herein, like element numbers are intended to indicate like elements or features.

### I. Introduction

As mentioned above, the pursuit of sustainable electrical energy is integral to addressing the escalating global demand for energy while minimizing detrimental environmental effects. To achieve this goal, a diverse array of energy sources and storage devices are strategically employed in various applications, including centralized generation, small distributed networks, and system energy recovery. A diverse array of novel power generation and storage technologies, including thermoelectric generators, battery cells, fuel cells, and photovoltaic panels, predominantly produce power in direct current (dc) form. These systems typically function at relatively low voltage ranges, extending from a few millivolts to several volts. The incorporation of such low-voltage energy sources, which operate in the range of a few millivolts to several volts, into existing dc microgrids (typically functioning at 120 to 380 V) or ac grids at 120 or 240 V may be facilitated by the use of dc-dc power converters capable of achieving extremely high voltage gains. These converters may play a role in facilitating the seamless connection between diverse energy sources and the grids.

In some embodiments, dc-dc power conversion may be performed by (i) isolated converters (which are characterized by the presence of galvanic isolation in the converter), or by (ii) non-isolated converters (which are characterized by the absence of galvanic isolation in the converter). Various non-isolated converters may be employed. Some such designs, however, suffer from high electromagnetic interference (EMI), low efficiency, or high active part counts. Further, non-isolated converters may be at risk of forming ground loops, short circuits or ground faults. Isolated converters may avoid some of these shortcomings (e.g., ground loops and the risk of ground faults) but some isolated converter designs may use high turns ratios to achieve high voltage gain, which may result in relatively high losses.

Some embodiments, however, include a topology for an isolated unidirectional or bidirectional converter, designed to surmount the deficiencies present in some isolated systems. This architecture integrates the advantages of resonant tank and transformer topologies to achieve a superior gain. By implementing zero voltage switching in both of its bridges, the converter significantly reduces the switching losses that may be associated with high-frequency operation. Additionally, the incorporation of interleaved planar transformers may mitigate the proximity effect and ac winding losses due to high primary currents, facilitating a high gain while maintaining low power loss across the circuit. To maximize the converter efficiency, this disclosure describes a loss optimization function employing E-GHA (Enhanced Generalized Harmonic Approximation) approach, which represents an improvement over the FHA (First Harmonic Approximation) and GHA (Generalized Harmonic Approximation) methodologies by refining the accuracy of the model. Consequently, the parameters of the converter components and the control variables may be optimized to maximize the efficiency of the converter across a wide voltage gain and load power range. Some embodiments include: (a) a resonant converter topology designed for an extremely high gain (>100); (b) a comprehensive methodology that fully integrates all harmonics for accurate reconstruction of primary and secondary voltages and currents within the isolated converter; (c) an exhaustive loss objective function and subsequent multi-objective optimization for the converter's components and control variables; and (d) an optimal set of control variables on a digital control platform, utilizing a E-GHA derived multivariate polynomial regression model with reduced computational complexity. Empirical verification has been employed to confirm the converter's efficiency and gain across various hardware experiments at multiple operational extremes.

### II. Converter Modeling

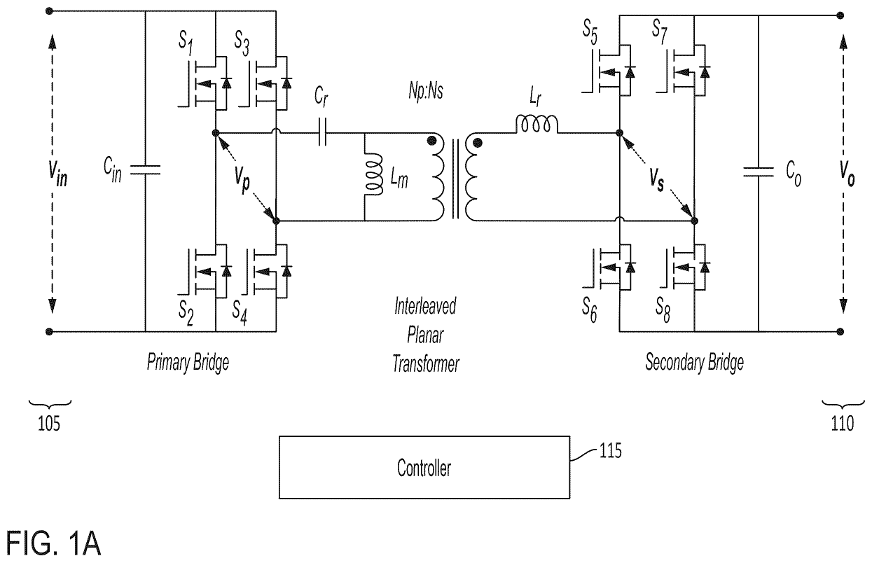

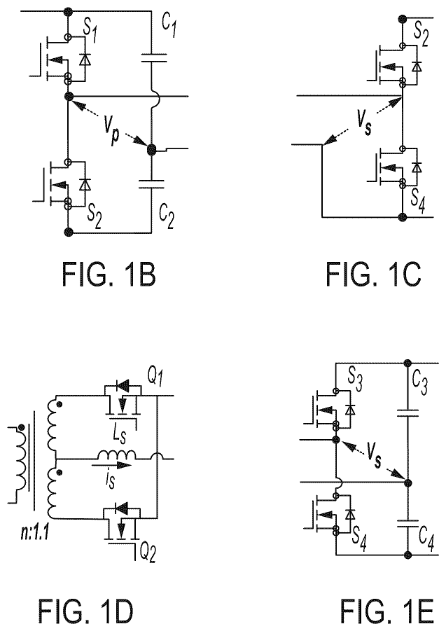

The topology for a bidirectional full-bridge capacitor-inductor-inductor (CLL) resonant converter, in some embodiments, is shown in FIG. 1A. The converter operates as a bidirectional dc-to-dc converter, capable of (i) converting received dc power (at a first (low) voltage (e.g., between 2.5 V and 4.0 V)) at a first port Vᵢₙ (105) to dc power (at a second (high) voltage (e.g., between 200 V and 400 V, e.g., at 360 V)) delivered out of a second port Vₒ (110), and of (ii) converting dc power received at the second port 110 to dc power delivered out of the first port 105. The converter uses an integrated multi-winding high-frequency planar transformer (HFPT), with turns ratio (Nₚ, Nₛ) and magnetizing inductance Lₘ, for galvanic isolation. A first winding of the transformer, which may be referred to as the “primary” winding, is connected through a resonant capacitor (Cᵣ) to the low-voltage switching circuit, which may be referred to as an inverting bridge. The low-voltage switching circuit may be connected to the first port 105, as illustrated. A second winding of the transformer, which may be referred to as the “secondary” winding of the transformer is connected through a resonant inductor (Lᵣ) to a high-voltage switching circuit, which may be referred to as a secondary rectifying bridge. The high-voltage switching circuit may be connected to the second port 110, as illustrated.

FIG. 1B shows a half-bridge circuit that may be used (instead of the primary full bridge shown in FIG. 1A) on the low-voltage side of the transformer. FIGS. 1C-1E show circuits that may be used (instead of the secondary full bridge shown in FIG. 1A) on the high-voltage side of the transformer, with FIG. 1C showing a half-bridge circuit, FIG. 1D showing a center-tapped circuit (which may be used with a center-tapped secondary winding, as shown), and FIG. 1E showing a voltage-doubler circuit.

A switching control circuit 115 may have connections (not shown in FIG. 1A) to various points in the converter (e.g., to the control terminals (e.g., gates) of the switches of the bridges, and to the two terminals of each of the first port 105 and the second port 110), and may (a) monitor one or more signals in the converter, e.g., one or more of (i) the voltage and current at the first port 105 and (ii) the voltage and current at the second port 110, and (b) generate control voltages (e.g., gate voltages) for the switches (e.g., field effect transistors (FETs)) of the first bridge and the second bridge, according to (i) the monitored signals and (ii) one or more external signals (e.g., external commands, such as a command to set the magnitude and direction of power flow between the first port 105 and the second port 110).

When power flows from the primary side of the converter to the secondary side, the first bridge may be used for converting dc received at the first port to pulse-width modulated ac, and the second bridge may be used for converting ac from the second winding of the transformer to dc at the second port. The switching waveforms of the first bridge and the second bridge may have the same frequency and a phase difference (which may be referred to as the “inter-bridge differential phase”) ϕ. The selection of the values of the resonant inductor (Lᵣ) and the resonant capacitor (Cᵣ) may be done based on achieving the required gain as well as minimizing the conduction and switching losses as described below. To achieve these objectives, it may be advantageous to have a precise model of the converter, which may enable the accurate determination of instantaneous port currents. As mentioned above, the converter may be capable of bidirectional operation, with power flowing (depending on operating conditions including the inter-bridge differential phase) either from the low-voltage port of the converter to the high-voltage port, or from the high-voltage port of the converter to the low-voltage port.

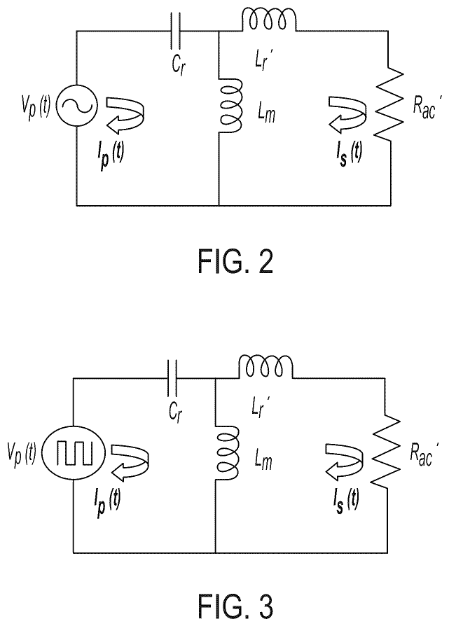

In some embodiments, a modeling approach based on a First Harmonic Approximation (FHA) may be used. The FHA based ac equivalent circuit referred to the primary side of the CLL converter is illustrated in FIG. 2 where the square wave output (Vₚ(t)) of the primary bridge is represented by the fundamental sinusoidal frequency voltage source (Vₚ) as shown in Equation 1. The output ac equivalent resistance is expressed as R_{ac} as shown in Equation 2.

$${V}_{p} ( t ) = \frac{4 {V}_{in}}{π} sin ( 2 π {F}_{s w} t ) \qquad ( 1 )$$

$${R}_{a c}^{′} = \frac{8 {R}_{L}^{′}}{{π}^{2}} \qquad ( 2 )$$

Here,

$${R}_{L}^{′}$$

is the output equivalent dc resistance referred to the primary side. Although this FHA-based modeling is fairly accurate when the switching frequency is close to the resonant frequency, this modeling approach may encounter specific constraints when dealing with high-frequency operations and secondary-side phase modulation. As the switching frequency diverges from the resonance point, which may occur in wide-gain power conversion, the errors introduced by FHA may become high, thus leading to miscalculations in loss estimation.

Generalized Harmonic Approximation (GHA) modeling may offer a more robust modeling framework compared to FHA. GHA provides greater adaptability when analyzing signal behavior across an extensive frequency range, effectively handles non-linearities, and delivers enhanced phase tracking precision. FIG. 3 presents a GHA-based ac equivalent circuit on the primary side of the CLL converter. The depiction in FIG. 3 portrays the primary voltage source as a quasi-square wave, encompassing both the fundamental and higher-order harmonics. This voltage source is mathematically represented as a summation of multiple odd-order sinusoidal voltage sources, as delineated in Equation 3.

$${V}_{p} ( t ) = \frac{4 {V}_{i n}}{π} {\sum }_{k = 1}^{2 m + 1} \frac{sin ( 2 π k {F}_{s w} t )}{k} \qquad ( 3 )$$

While GHA can effectively model primary side currents with accuracy, the modeling of secondary side currents may exhibit severe inaccuracies. This stems from the assumption of the secondary side ac terminal impedance being resistive in nature, which is similar as the FHA approach of Equation 2 (described above). A resistive impedance approximation may hold true based on assuming exact phase alignment between harmonic voltage and current components. However, although synchronous rectification (SR) may cause phase alignment of the fundamental voltage-current components, the higher order harmonics may not be in phase due to the non-sinusoidal secondary current, causing the equivalent higher-order harmonic impedances to be non-resistive and causing the GHA model to exhibit poor accuracy.

Given the wide gain range and significant deviation of the operating frequency from the resonant frequency in the converter, some embodiments employ an approach referred to herein as enhanced GHA (E-GHA). This approach (i) incorporates a non-approximated inclusion of both primary and secondary voltage and current harmonics along with their respective phase information through a unified circuit derivation and (ii) includes a verification of the model.

A. E-GHA based CLL Model Formulation

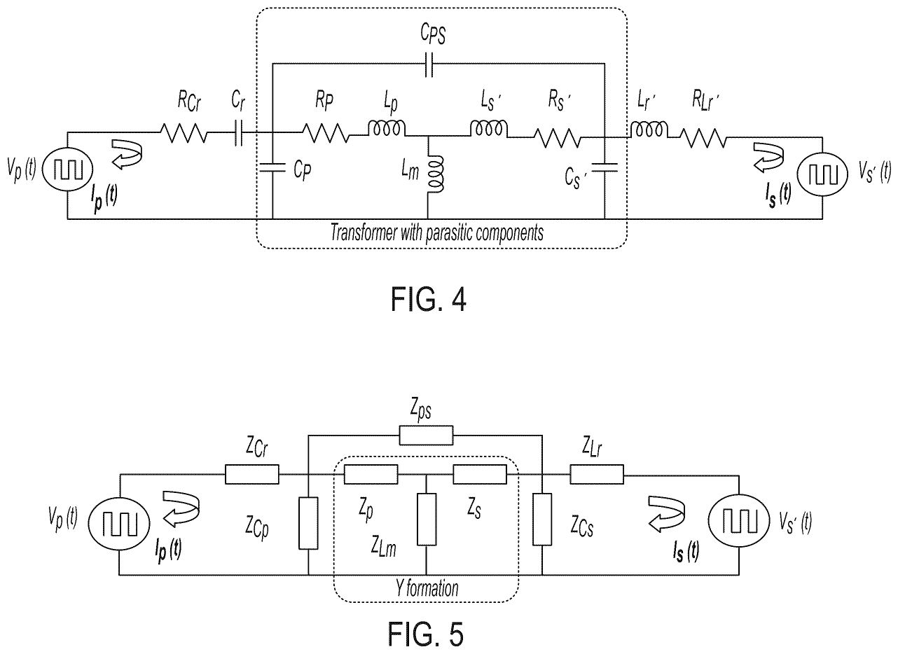

Unlike the FHA and GHA models, the E-GHA model integrates a comprehensive representation of both primary and secondary voltage and current harmonics. For the purpose of modeling, the total output dc power is considered to equal the sum of the input ac active power for all harmonic components. Moreover, to further increase the model accuracy, all possible non-ideal parasitic elements are included in the model, as illustrated in FIG. 4. The parasitic inclusive model includes the resonant capacitor equivalent series resistance (ESR), intra-winding and interwinding capacitance and inductance of the interleaved planar transformer and the dc resistance (DCR) of the secondary side inductor. The primary and secondary side impedances derived from FIG. 4 for the k^{th} harmonic of the switching frequency are the following:

$${\hat{Z}}_{p , k} = {R}_{p} + j 2 π {F}_{s w} k {L}_{p} , {\hat{Z}}_{s , k} = \frac{{N}_{p}}{{N}_{s}} ( {R}_{s} + j 2 π {F}_{s w} k {L}_{s} ) , \qquad ( 4 )$$

$${\hat{Z}}_{L m , k} = j 2 π {F}_{s w} k {L}_{m} , {\hat{Z}}_{c p , k} = - j \frac{1}{2 π {F}_{s w} k {C}_{p}} ,$$

$${\hat{Z}}_{c s , k} = - j \frac{1}{2 π {F}_{s w} k {C}_{s}} ,$$

$${\hat{Z}}_{c m , k} = - j \frac{1}{2 π {F}_{s w} k {C}_{m}} ,$$

$${V}_{s} ( t ) = \frac{{N}_{p}}{{N}_{s}} \frac{4 {V}_{s}}{{π}^{2}} {\sum }_{k = 1}^{2 m + 1} \frac{sin ( 2 π {F}_{s w} kt - k ϕ )}{k}$$

$${I}_{p} ( t ) = {I}_{p p} ( t ) + {I}_{p s} ( t ) \qquad ( 5 )$$

$${I}_{s} ( t ) = \frac{{N}_{p}}{{N}_{s}} ( {I}_{s s} ( t ) + {I}_{s p} ( t ) ) \qquad ( 6 )$$

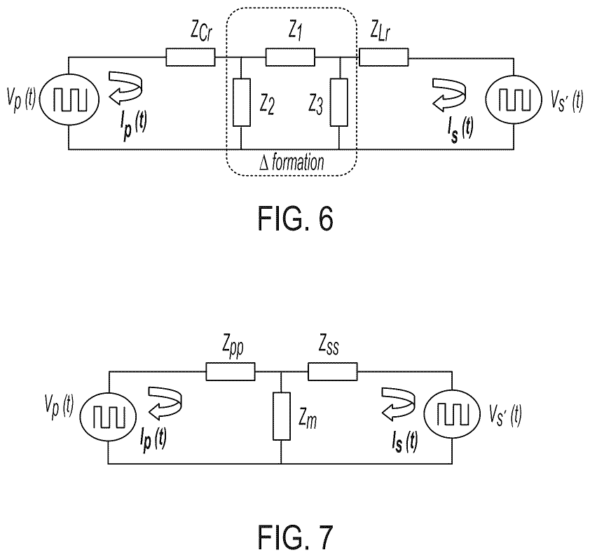

A Y-Δ transformation may be performed, to simplify the k^{th} harmonic impedance diagram, using \hat{Z}_{p,k}, \hat{Z}_{s,k} and \hat{Z}_{Lm,k} and thus the circuit of FIG. 5, may be modified, using the Y-Δ transformation, to form the circuit of FIG. 6. This circuit may then be further simplified by performing the paralleling operation between the corresponding branches of FIG. 6 and finally performing a Δ-Y transformation. The simplified circuit that may result is illustrated in FIG. 7. From the figure, it may be seen that the full bridges are represented as voltage sources Vₚ and V′ₛ, derived from Equations 3 and 4, respectively.

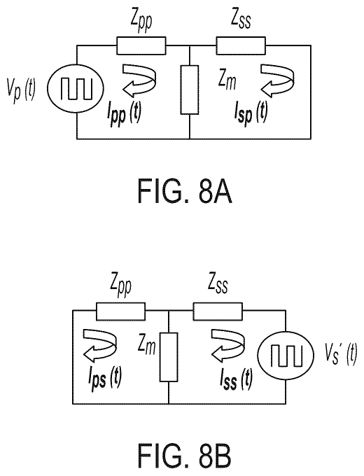

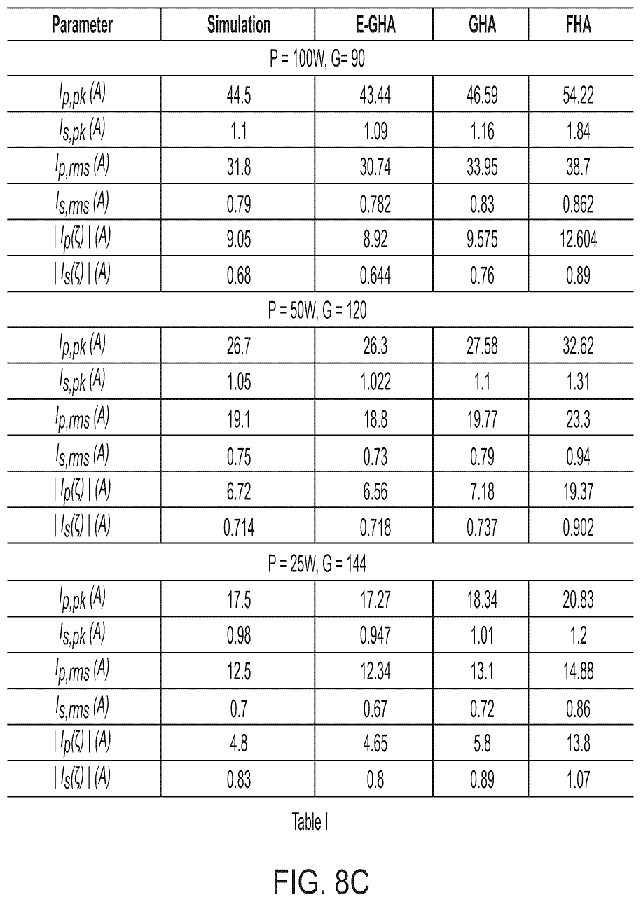

The following derivation aims to capture the time-domain dynamics of primary and secondary port currents and subsequently to formulate the ac active port power expressions. Since there are multiple voltage sources present in the equivalent circuit of FIG. 7, the primary and secondary side currents are determined using linear superposition as shown in FIG. 8A and FIG. 8B, and the primary and secondary side currents are expressed as Equations 5 and 6, where the components of the current due to the two voltage sources Vₚ and V′ₛ may be determined based on the circuits of FIG. 8A and FIG. 8B respectively, and the total current may be calculated as the sum of these components. To further simplify the equations, the impedance parameters for these circuits are constructed as follows:

$${\hat{Z}}_{p r , k} = {\hat{Z}}_{s s , k} ‖ {\hat{Z}}_{m , k} , {\hat{Z}}_{s r , k} = {\hat{Z}}_{p p , k} ‖ {\hat{Z}}_{m , k} ,$$

$${\hat{Z}}_{p t , k} = {\hat{Z}}_{p r , k} + {\hat{Z}}_{pp , k} , {\hat{Z}}_{s t , k} = {\hat{Z}}_{s r , k} + {\hat{Z}}_{s s , k}$$

Therefore, the superposed current from FIG. 8A may be expressed as:

$${I}_{pp} ( t ) = \vert {V}_{p} \vert {\sum }_{k = 1}^{2 m + 1} \frac{sin ( 2 π {F}_{sw} kt - ∠ {\hat{Z}}_{pt , k} )}{k \cdot \vert {\hat{Z}}_{pt , k} \vert} \qquad ( 7 )$$

$${I}_{sp} ( t ) = \vert {V}_{p} \vert {\sum }_{k = 1}^{2 m + 1} \frac{k}{\vert {\hat{Z}}_{ss , k} \vert} \frac{\vert {\hat{Z}}_{pr , k} \vert}{\vert {\hat{Z}}_{pt , k} \vert} sin ( 2 π {F}_{sw} kt - ∠ {\hat{Z}}_{pr , k} - ∠ {\hat{Z}}_{ss , k} - ∠ {\hat{Z}}_{pt , k} ) \qquad ( 8 )$$

Similarly, the superposed current from FIG. 8B may be expressed as:

$${I}_{ss} ( t ) = \vert {V}_{s}^{′} \vert {\sum }_{k = 1}^{2 m + 1} \frac{sin ( 2 π {F}_{sw} kt - k {ϕ}_{s} - ∠ {\hat{Z}}_{st , k} )}{k \cdot \vert {\hat{Z}}_{st , k} \vert} \qquad ( 9 )$$

$${I}_{ps} ( t ) = \vert {V}_{s}^{′} \vert {\sum }_{k = 1}^{2 m + 1} \frac{k}{\vert {\hat{Z}}_{pp , k} \vert} \frac{\vert {\hat{Z}}_{sr , k} \vert}{\vert {\hat{Z}}_{st , k} \vert} sin ( 2 π {F}_{sw} kt - k {ϕ}_{S} + ∠ {\hat{Z}}_{sr , k} - ∠ {\hat{Z}}_{pp , k} - ∠ {\hat{Z}}_{st , k} ) \qquad ( 10 )$$

Hence, the primary and secondary currents can be ascertained through Equations 5 and 6. The rms values for current and voltage can be determined using Equations 11-14 (below). Thus, the simplified voltage gain can be determined for the load resistance R using Equation 15. Moreover, the primary and secondary ac port powers can be determined using Equations 16 and 17 respectively. Under the assumption of an ideal lossless circuit, the ac port powers equal the output load power. Analytical solutions to Equations (11-17) may provide the required control variable parameters which may later be optimized for different input voltage and power levels.

$${V}_{prms , k} = \frac{4 {V}_{p}}{π k \sqrt{2}} \qquad ( 11 )$$

$${V}_{srms , k} = \frac{4 {V}_{s}}{π k \sqrt{2}} \qquad ( 12 )$$

$${I}_{prms , k} = \frac{\vert {I}_{p , k} \vert}{\sqrt{2}} \qquad ( 13 )$$

$${I}_{srms , k} = \frac{\vert {I}_{s , k} \vert}{\sqrt{2}} \qquad ( 14 )$$

$$G = \frac{64 R}{\sqrt{2} {π}^{3}} {\sum }_{k = 1}^{2 m + 1} \frac{{k}^{2} \vert {\hat{Z}}_{pr , k} \vert + \vert {\hat{Z}}_{ss , k} \vert}{{k}^{4} \vert {\hat{Z}}_{pt , k} \vert \vert {\hat{Z}}_{ss , k} \vert} \qquad ( 15 )$$

$${P}_{p , ac} = {\sum }_{k = 1}^{2 m + 1} {V}_{prms , k} {I}_{prms , k} cos ( - ∠ {I}_{p , k} ) \qquad ( 16 )$$

$${P}_{s , ac} = {\sum }_{k = 1}^{2 m + 1} {V}_{srms , k} {I}_{srms , k} cos ( k {ϕ}_{s} - ∠ {I}_{s , k} ) \qquad ( 17 )$$

### B. E-GHA Based CLL Model Verification

To substantiate the accuracy of the E-GHA model, an analytical comparison was conducted between the primary and secondary side currents derived from the three methodologies previously discussed, against their simulated counterparts. A detailed simulation model of the CLL converter was developed using Piecewise Linear Electrical Circuit Simulation (PLECS™) to facilitate this verification process. The parameters of the components and parasitics, which are used to verify the model, are discussed below. For a comprehensive model validation, three distinct operational scenarios comprising different input voltages and power levels such as (4 V, 100 W), (3 V, 50 W) and (2.5 V, 25 W) were selected.

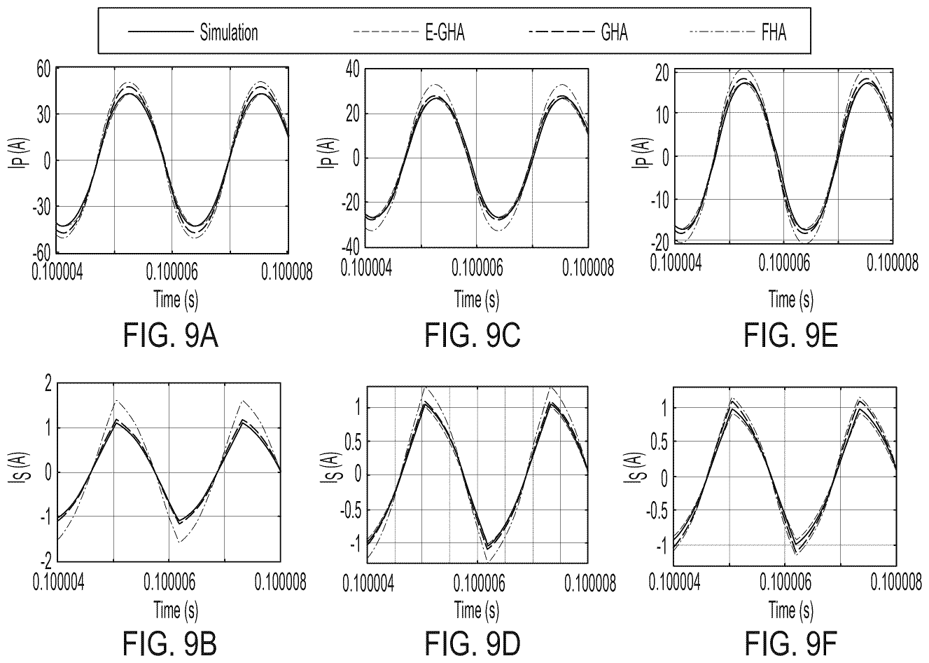

The comparison of the current waveforms for these scenarios, as illustrated in FIGS. 9A-9F, has served to assess the precision of the E-GHA model. The analysis, further detailed in Table I (FIG. 8C) (which shows a comparison, against a simulation, of the E-GHA based model, the GHA based model and the FHA based model based on primary and secondary port current parameters), encompasses the peak, rms, and switching instant values of the port currents, offering a succinct summary of the models' relative accuracies. While the GHA model demonstrates a reasonable accuracy in estimating peak and RMS currents, with an average error percentage of less than or equal to 5%, it notably falls short in accurately predicting the switching instant values, especially under light load conditions where the error margin exceeds 10% for both the GHA and FHA models. This discrepancy underscores a potential inadequacy in the GHA model for defining precise zero voltage switching criteria. In contrast, the E-GHA model, maintaining an error percentage of less than or equal to 5% for switching instant values, stands out as a robust methodology for the precise calculation of semiconductor switching losses.

### III. E-GHA Derived Loss Model Formulation

A converter according to some embodiments not only satisfies the gain requirements but also minimizes power losses. Consequently, a comprehensive loss model may be useful, encompassing the optimization of not only the converter's resonant components but also its control variables. To formulate the loss model, the primary and secondary side currents are utilized, as derived in Equations 5 and 6. The focus is primarily on minimizing total losses associated with power devices on both the primary and secondary sides, i.e., losses in the entire switching network, as well as the resonant capacitor and inductor.

### 1) Conduction Loss Model Formulation

The total conduction loss can be expressed as Equation 18. The four components in this equation represent the conduction losses of the primary device, secondary device, capacitor equivalent series resistance (ESR) loss, and inductor direct current resistance (DCR) loss, respectively.

$${P}_{cond} = {I}_{p , rms}^{2} \cdot ( 2 \cdot {R}_{dson , p} + {R}_{c} ) + {I}_{s , rms}^{2} \cdot ( 2 \cdot {R}_{dson , s} + {R}_{1} ) \qquad ( 18 )$$

### 2) Switching Loss Model Formulation

As the converter is operated at a very high frequency, it may be advantageous to secure zero voltage switching in both the full bridges. The switching loss function and zero voltage switching constraints are discussed in this section. The switching loss can be expressed as the sum of two losses namely voltage current (VI) overlap loss (P_{s,vi}) and capacitor charging-discharging loss (P_{s,c}) and during the switching instance as shown in Equation 19.

$${P}_{sw} = {P}_{s , vi} + {P}_{s , c} \qquad ( 19 )$$

$${P}_{s , vi} = {\sum }_{d = p , s} {\sum }_{m = 1}^{2} [ 2 {V}_{d , dc} \vert {i}_{d} ( {τ}_{d , m} ) \vert {F}_{SW} {t}_{off , d , m} + 2 α {V}_{d , dc} {i}_{d} ( {τ}_{d , m} ) {F}_{SW} {t}_{on , d , m} \qquad ( 20 )$$

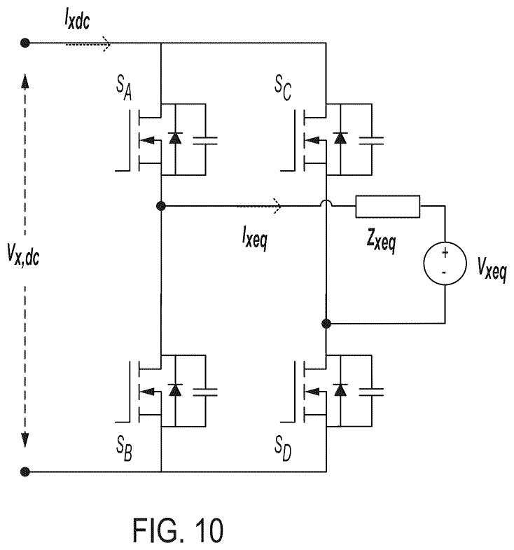

Equation 20 expresses the V-I overlap switching loss where V_{d,dc} is the dc voltage, i_{d}(τ_{d,m}) is the instantaneous current, and α is the ratio of the voltage at the device turn-on to the dc blocking voltage of the device. By achieving zero voltage switching (ZVS), the switching loss can be decreased by making the device turn on loss equal to zero. ZVS may be achieved if the voltage across a switch, just before the switch is turned on, is less than a fraction, e.g., 1% (or a fraction between 0.5% and 5%) of the DC blocking voltage during the switch-off state. To achieve zero voltage switching, the charge equivalent output body capacitor (Cₒₛₛ) may be discharged before the turn-on transition. Therefore, the phase of the port current may lag behind the port voltage which is determined by the set of operational control variables applied to the converter and may be met by operating the converter in the inductive region. Moreover, a certain minimum amplitude of magnetizing current may be present for zero voltage switching. To assess the feasibility of ZVS in both the primary and secondary side full-bridge, an equivalent Thevenin circuit model may be constructed, as shown in FIG. 10, where S_{A}, S_{B}, S_{C} and S_{D} denote (S₁, S₅), (S₂, S₆), (S₃, S₇) and (S₄, S₈) respectively. The Thevenin equivalent voltage and impedance for both the primary and secondary sides are determined as shown in Equations 21-23.

$${\hat{V}}_{p , TH , k} = \frac{{\hat{V}}_{s , k} {\hat{Z}}_{m , k}}{{\hat{Z}}_{m , k} + {\hat{Z}}_{ss , k}} \qquad ( 21 )$$

$${\hat{Z}}_{p , TH , k} = {\hat{Z}}_{pp , k} + ( {\hat{Z}}_{m , k} \vert \vert {\hat{Z}}_{ss , k} ) \qquad ( 22 )$$

$${\hat{V}}_{p , TH} ( t ) = {\sum }_{k = 1 , 3 , 5 , …}^{∞} \vert {\hat{V}}_{p , TH , k} \vert sin ( 2 π {F}_{SW} kt + ∠ {\hat{V}}_{p , TH , k} ) \qquad ( 23 )$$

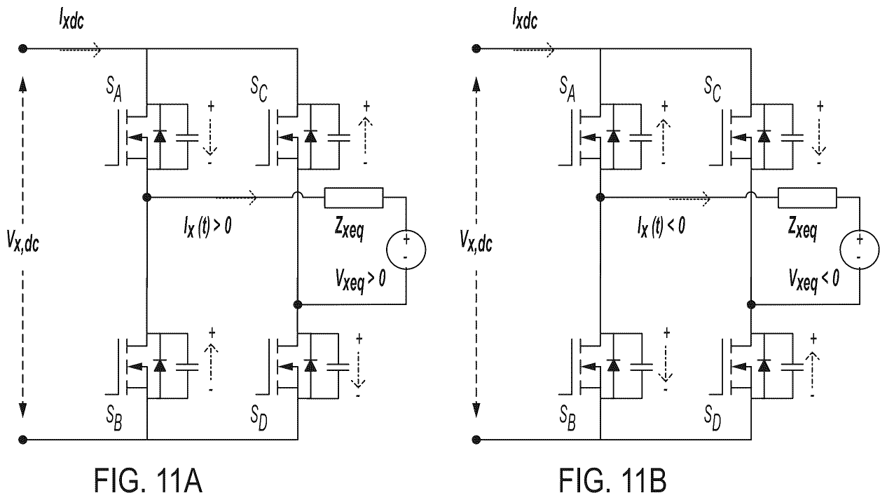

The zero voltage switching criteria for the inverting mode is described here. Based on the circuit representation in FIG. 11A, and considering the currents at the turn-ON instant for switches S_{B} and S_{C} at the switching instant t=ζ, the total absorbed energy (E_{abs}) and provided energy (Eₚᵣ) by the Thevenin port voltage V_{p,TH} are given by:

$${E}_{abs} = 2 {C}_{oss , p} {V}_{p , TH , τ} {V}_{p , dc} \qquad ( 24 )$$

$${E}_{pr} = {\int }_{τ}^{τ + {t}_{ZVS}} {V}_{p , TH} ( t ) {I}_{p , TH} ( t ) \qquad ( 25 )$$

where t_{zvs} is the time required to completely discharge C_{oss,p}. The energy in the switch remains constant during the commutation interval (the time interval beginning when a switch turns off and ending when the complementary switch turns on), leading to the constraint Eₚᵣ≥E_{abs} for ZVS for the inverting mode, shown in Equation 26:

$${\int }_{τ}^{τ + {t}_{ZVS}} {V}_{p , TH} ( t ) {I}_{p , TH} ( t ) \geq 2 {C}_{oss , p} {V}_{p , TH , τ} {V}_{p , dc} \qquad ( 26 )$$

I_{p,TH,min} can be determined using Equation 26. If the instantaneous current during the turn-on is higher than the minimum current |I_{p,TH,min}|, the devices will have zero turn-on switching overlap loss as shown in Equation 27.

$${P}_{s , vi} = {\sum }_{d = p , s} {\sum }_{m = 1}^{2} [ 2 {V}_{d , dc} \vert {i}_{d} ( {τ}_{d , m} ) \vert {F}_{SW} {t}_{off , d , m} \qquad ( 27 )$$

where t_{off,d,m} is given by:

$${t}_{off , d , m} = \frac{{Q}_{gd , d , m} {R}_{g , d , m}}{{V}_{pl , d , m}} + {R}_{g , d , m} {C}_{in , d , m} ln ( \frac{{V}_{pl , d , m}}{{V}_{th , d , m}} ) \qquad ( 28 )$$

The currents at the turn-ON instant for switches S_{A} and S_{D} may be analyzed in an analogous manner based on the circuit representation in FIG. 11B. The device parameters such as Q_{gd}, R_{g}, Vₚₗ, Cᵢₙ, and Vₜₕ may be obtained from the datasheets of the respective power devices.

During partial soft-switching cases, Cₒₛₛ remains partially charged, thus making the P_{s,c} non-zero as shown in Equation 29, where ΔV_{d} represents the residual drain-source voltage at the turn-on instant of the switching device.

$${P}_{s , c} = {\sum }_{d = p , s} {\sum }_{m = 1}^{2} [ 2 ( {E}_{oss , d} ( Δ {V}_{d}^{m} ) + \{ {Q}_{oss , d} ( {V}_{in} ) - {Q}_{oss , d} ( {V}_{d} - Δ {V}_{d}^{m} ) \} {V}_{d} - \{ {E}_{oss , d} ( {V}_{d} ) - {E}_{oss , d} ( {V}_{d} - Δ {V}_{d}^{m} ) + 0.5 {C}_{oss , d} {V}_{d}^{2} {F}_{sw} ] \qquad ( 29 )$$

### IV. Component Parameter and Control Variable Optimization

### A. Optimization of Resonant Tank Components

The magnetizing inductance (Lₘ), resonant capacitor (Cᵣ), and resonant inductor (Lᵣ), integral components of the converter, contribute to the normalized intrinsic resonant gain, while the transformer turns ratio supplements the gain as needed. However, employing a high turns ratio in the transformer can substantially decrease converter efficiency. This is primarily due to the increase in transformer ac loss associated with higher turns ratios. Consequently, one objective of the converter design is to strategically select these three parameters—resonant capacitance, inductance, and magnetizing inductance—to achieve the desired gain with minimal power loss. In pursuit of this goal, a comprehensive analysis is conducted by plotting the maximum achievable gain against the values of Cᵣ and Lᵣ, for a single value of Lₘ at the nominal loading condition.

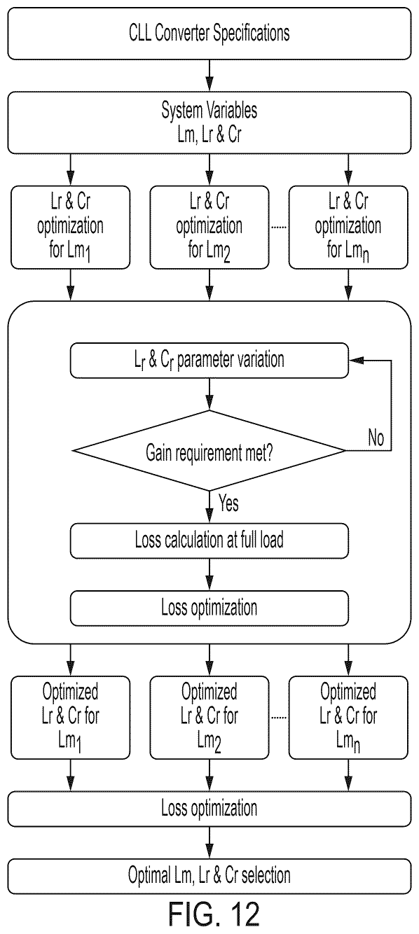

Graph points meeting the minimum required gain criteria, set at 7.5 in this instance, are singled out for further examination. This predetermined gain threshold is established so as to maintain a maximum turns ratio, of the transformer, below 20 to limit the transformer ac winding loss as mentioned above. The selected points are then evaluated against the approximate total conduction and switching losses of the converter using the loss model formulated above. The optimization process is illustrated in FIG. 12. Because the transformer gain ratio may contribute the remaining required gain, the losses may then be calculated. By evaluating the lowest loss point, the optimal values for Cᵣ and Lᵣ are determined in this case.

The optimization may be a constrained optimization that numerically finds parameter values (e.g., circuit parameters (such as values of Cᵣ, Lᵣ, Lₘ, Nₚ, and Nₛ), or operating parameters (e.g. the switching frequency or the inter-bridge differential phase ¢)) corresponding to the optimum (e.g., maximum or minimum) value of an objective function. The constraint (which may, e.g., constrain the dc-to-dc converter to operate with zero-voltage switching) may be enforced during the optimization by rejecting any parameter value combinations that result in behavior violating the constraint. The objective function may be a weighted average of the efficiency or of the total loss (including, e.g., conduction and switching losses). The weighted average may be an average over various states of the converter, weighted, e.g., in proportion to the fraction of operating time the converter is expected to spend in each state. For example, for a system in which the low-voltage side of the converter is connected to a battery and the high-voltage side of the converter is connected to a grid, the averaging may be over various states of discharge of the battery (and the corresponding voltage at the first port) and over states corresponding to charging operation (during which the battery is charged from the grid) and discharging operation (during which the battery is discharged into the grid).

### B. Control Variable Optimization for Different Operating Conditions

The loss models outlined above may be used to compute the overall semiconductor loss for the converter. Given the requirement for the converter to function under various load and input voltage scenarios, the control variables to be optimized may differ across different conditions. Consequently, control variables deemed optimal for nominal scenarios may not retain their optimality under alternative operational conditions. To elucidate this point, control variable sets for various voltage-power configurations are optimized, which are constructed utilizing Equations 11-17, depict power transfer magnitude as a function of both switching frequency and phase shift. The identification of specific points satisfying the power transfer criterion relies on the intersection of the power contour and the corresponding power plane. The control variables that meet both the zero-voltage switching (ZVS) criteria and the necessary voltage-power specifications at the output are subsequently isolated. These selected control variables then become the operational parameters for an additional loss optimization algorithm. Considering that it is improbably that a single control variable will optimize the cost function's three facets—total semiconductor loss, conduction loss, and switching loss—simultaneously for a given voltage-power profile, the optimization point for the total loss is selected for use in the hardware setup, as it promises the highest efficiency. Additionally, it is noteworthy that the optimal condition points for conduction loss and total loss are nearly identical, emphasizing the dominant role of conduction loss over switching loss. This pattern persists across the rest of the operating points as well. Moreover, an analysis of the data presented in the figures reveals a negative correlation between conduction loss and switching frequency. This trend can be attributed to the fact that an increase in switching frequency, especially near the resonant frequency, results in a lower input impedance phase angle. This shift diminishes the reactive power proportion within the total power transfer. Under steady voltage-power conditions, the control variable utilizing the highest switching frequency—while remaining below the resonant frequency—yields the minimal rms current values. Furthermore, upon analyzing the figures, it can be noted that the optimal switching frequency, as well as the phase difference, increases when the load decreases. This can be attributed to the disproportionate change in input voltage and current of the converter. The correlation among the optimized operating control points and the condition cases are further discussed below.

In some embodiments, the optimization of the circuit parameters (such as values of Cᵣ, Lᵣ, Lₘ, Nₚ, and Nₛ), and of the operating parameters (e.g. the switching frequency or the inter-bridge differential phase ϕ) may be performed in two stages, with a first stage using certain assumed nominal operating conditions to find optimum values for the circuit parameters, and a second stage finding optimum control variable parameters using the optimal circuit parameters found in the first stage. These two stages may be repeated (and, for example, for a second iteration of the first stage, the operating parameters found during the first iteration of the second stage may be used. Any suitable numerical optimization method (e.g., a gradient descent method) may be employed to find the optimum values at either stage.

### V. Implementation and Execution of Optimized Switching Modulation Strategy

As indicated above, control parameters at different corner points of the system exhibit significant variations and hence need to be synthesized online based on the sensed feedback variables. In some embodiments, multi-dimensional look-up tables (LUTs) may be deployed in digital control systems for such optimization, but these methods encounter considerable limitations due to restricted memory capacity and the complexities involved in pinpointing an exact match for control variables within the LUTs. The challenge escalates with an increase in the number of variables, especially when their values are close to each other. Given the minor variations in both switching frequency and phase in some scenarios considered herein, creating a high-resolution LUT may be impractical as it may not yield the most optimized set of control variables. As such, some embodiments employ a multivariate polynomial regression method. This method is capable of calculating the optimal set of control variables for all conceivable voltage and power conditions, subsequently integrating this data back into the control system via voltage and current sensors. A mathematical model is established to systematically ascertain all potential control variables across various voltage and power conditions. To formulate the algorithm and determine the coefficients, the optimal control variables achieved for different voltage-power combinations are utilized.

The algorithm calculates coefficients and intercepts on a high-performance computer using a least mean square error (LMSE) estimator, with tools such as MATLAB™'s Polynomial Regression toolbox being well suited for these complex computations. The chosen polynomial model's complexity influences both the model's accuracy and the required computational time. If the calculation of control variables exceeds the converter's switching period, it could lead to a reduced control loop update frequency and potential signal aliasing or loop instability. In the digital signal processor (DSP), the computation of control variables via polynomial regression involves executing a series of mathematical operations, such as multiplications and additions. The cumulative computational time should not surpass the switching period to prevent slowing down the control loop updates compared to the switching and sampling rates. To ensure efficient computation, a single-core 150 MHz processor TMS 320F 28335 may be employed. For instance, evaluating a third-order polynomial may involve 40 multiplications and 18 additions for each control variable.

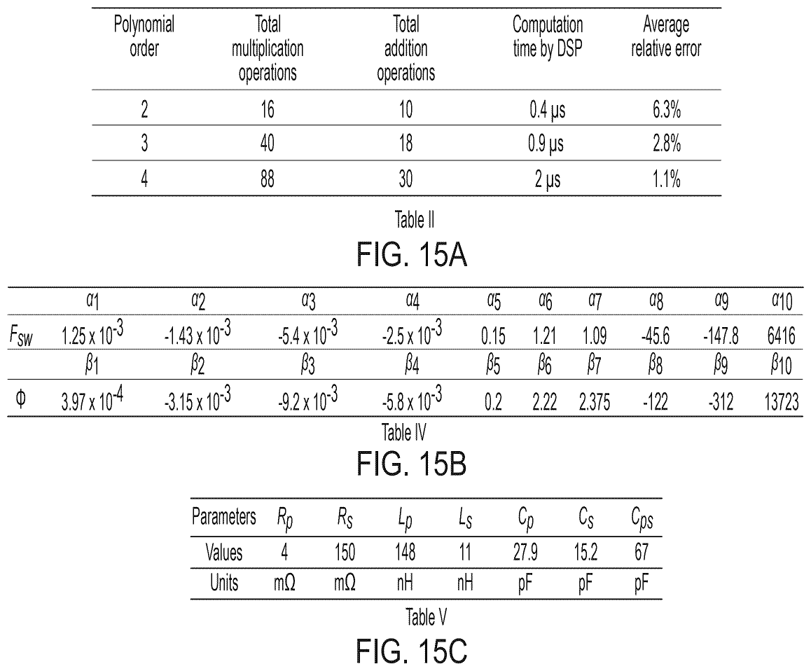

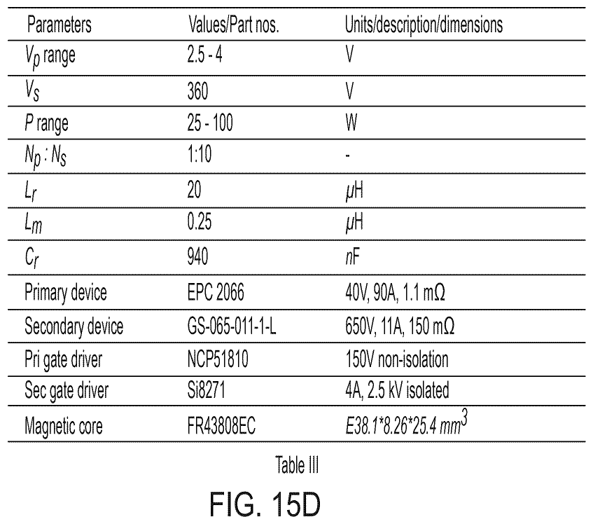

The following analysis, as illustrated in Table II (FIG. 15A, showing computation details by polynomial order), evaluates both the approximate execution time and the relative accuracy for second, third and fourth-order polynomial functions. The analysis reveals that although a fourth-order polynomial offers the highest accuracy with an error margin of 1.1% in determining control variables, the execution time surpasses the upper limit for (>500 kHz) switching. Therefore, a third-order polynomial may be utilized. The control variables are expressed as third-order polynomial functions as shown in Equations 30 and 31.

$${F}_{sw} = {α}_{1} {P}^{3} + {α}_{2} {P}^{2} G + {α}_{3} {PG}^{2} + {α}_{4} {G}^{3} + {α}_{5} {P}^{2} + {α}_{6} PG + {α}_{7} {G}^{2} + {α}_{8} P + {α}_{9} G + {α}_{10} \qquad ( 30 )$$

$$ϕ = {β}_{1} {P}^{3} + {β}_{2} {P}^{2} G + {β}_{3} {PG}^{2} + {β}_{4} {PG}^{2} + {β}_{4} {G}^{3} + {β}_{5} {P}^{2} + {β}_{6} PG + {β}_{7} {G}^{2} + {β}_{8} P + {β}_{9} G + {β}_{10} \qquad ( 31 )$$

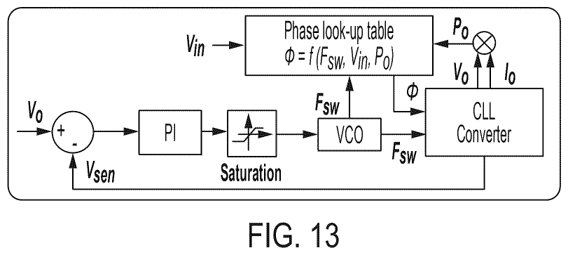

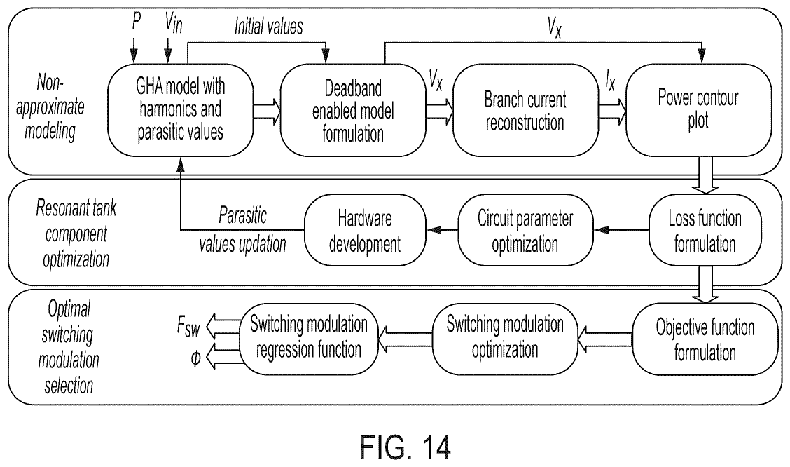

The coefficients α and β, integral components of the polynomials outlined in Table IV (shown in FIG. 15B), may be computed through the utilization of optimized control variable sets. These sets correspond to all the distinctive corner cases of power-gain combinations, as delineated above. The modeling and optimization process is summarized in FIG. 14. Moreover, a closed-loop controller may be used to regulate the output voltage during charging and discharging events; an example of a design for such a controller is shown in FIG. 13.

### VI. Hardware Prototyping and Experimental Verifications

### A. Hardware Prototyping

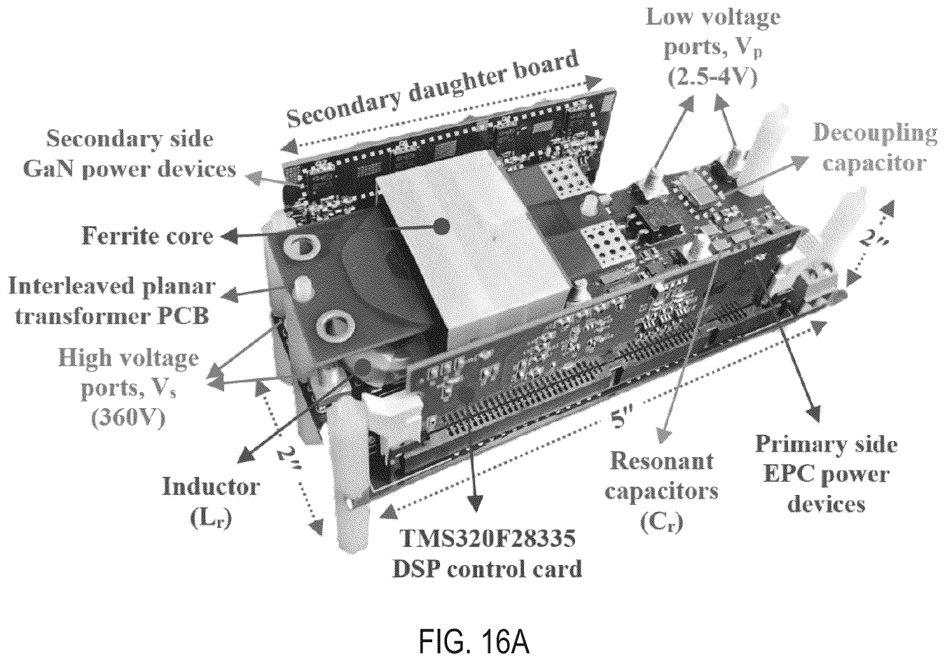

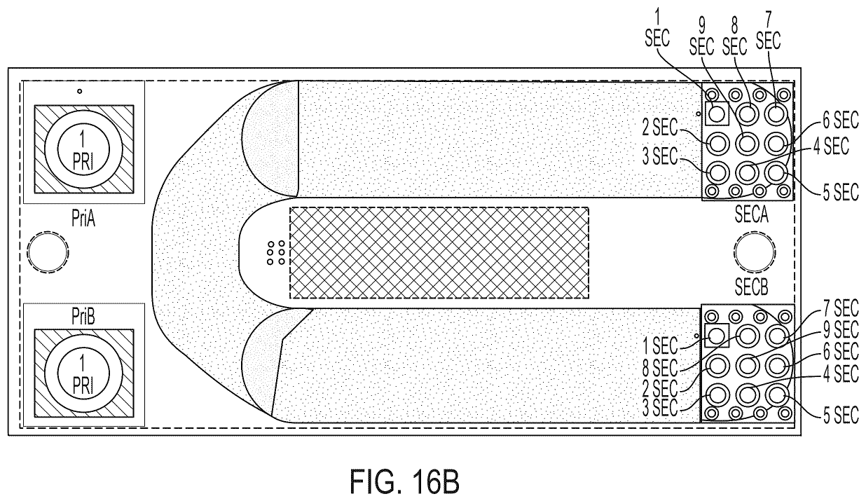

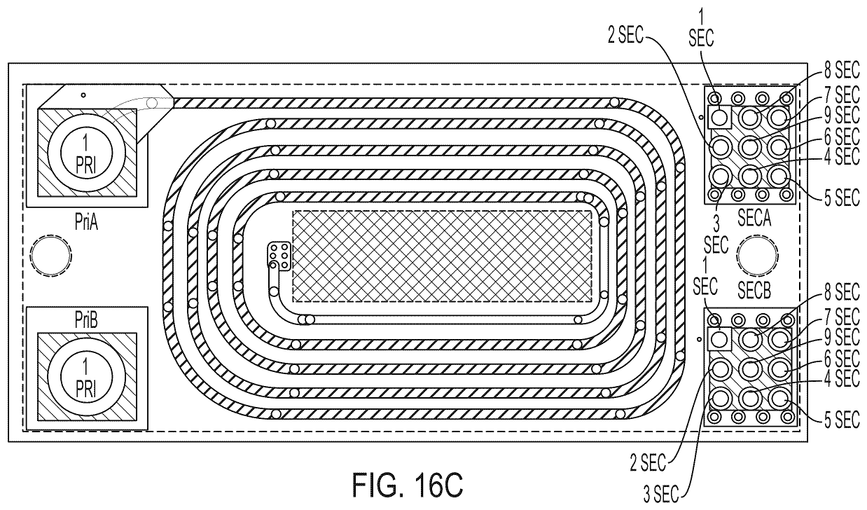

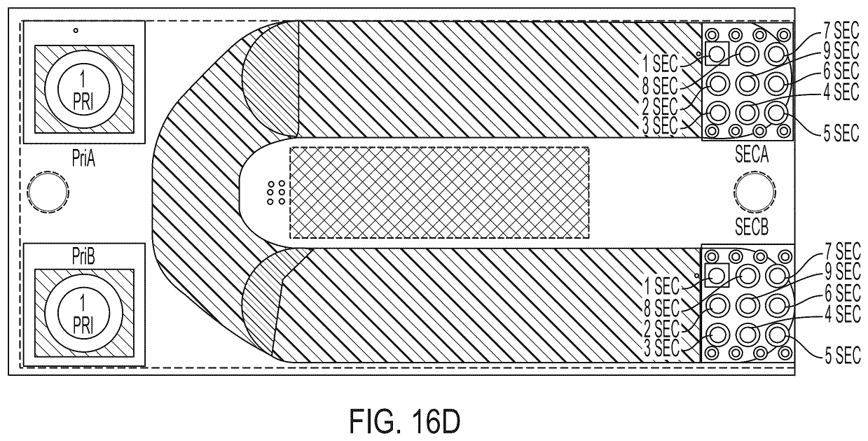

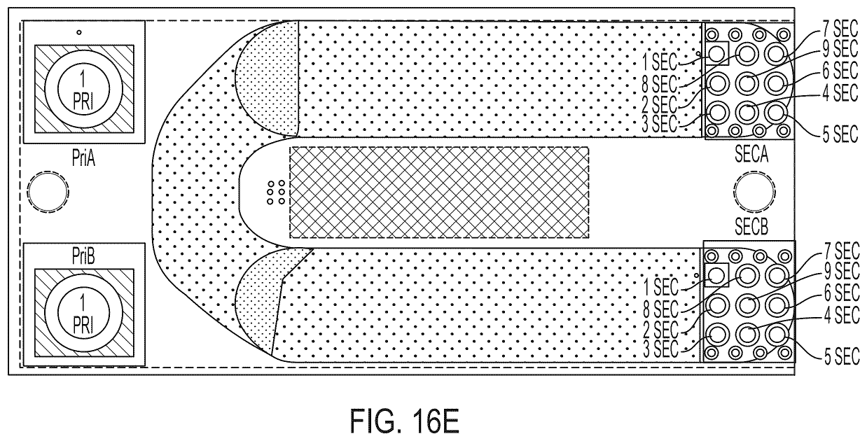

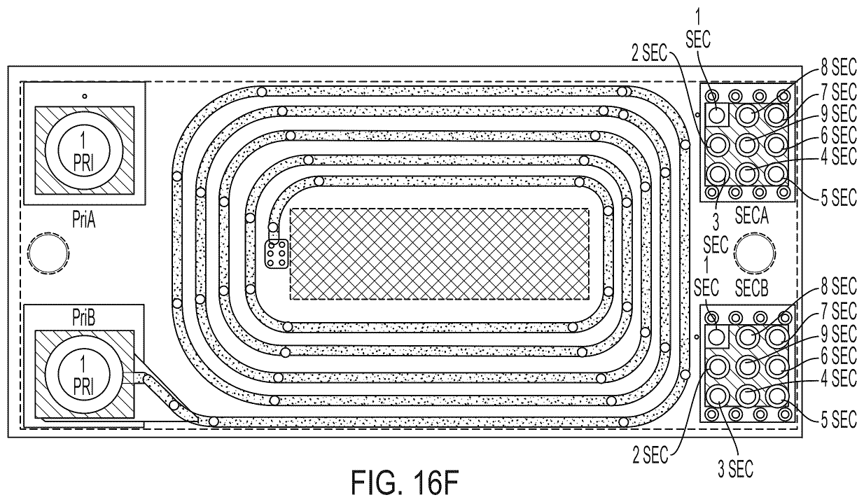

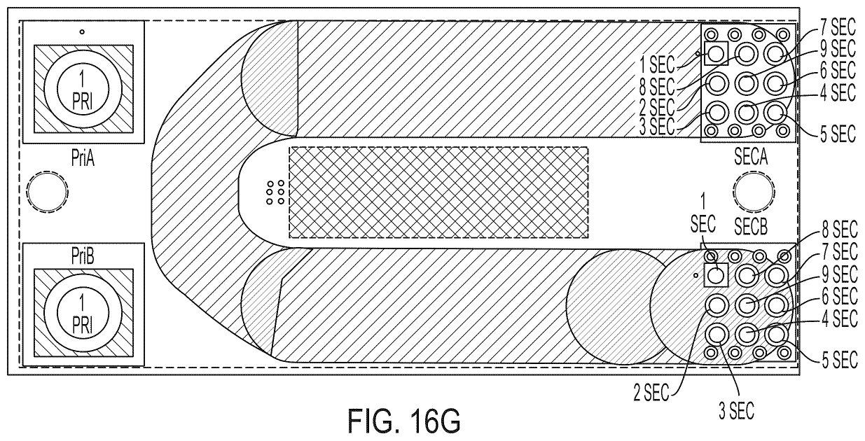

A hardware prototype has been engineered and constructed for the purpose of conducting experimental evaluations and substantiating the efficacy of a CLL converter for a 2.5-4 V to 360 V dc-dc conversion, in one embodiment, as illustrated in FIG. 16A. Design specifications for this design are shown in Table III (FIG. 15D). This prototype includes four fundamental elements: (a) the primary board, which accommodates the primary low voltage side full bridge utilizing 40 V/90A GaN FETs (EPC2066), resonant capacitors, sensors, and auxiliary components of the converter; (b) the secondary board, which contains the dc link-side high voltage full bridge comprising 650 V/7.5A GaN FETs (GS0650111L) and resonant inductor; (c) an R-type ferrite core-based interleaved planar transformer to minimize the high-frequency ac loss, and (d) a single-core DSP TMS 320F28335 that operates as a switching control circuit 115 (FIG. 1A) for controlling the FETs. The converter's physical dimensions are compactly confined to a volume of 5″×2″×2″ so that it can be easily integrated with prismatic cells of similar form factor. FIGS. 16B-16G show the six layers, in order, of a printed circuit board that forms the windings, in some embodiments. To mitigate winding losses in the transformer due to high primary side currents, four layers (the layers of FIGS. 16B, 16D, 16E, and 16G) are connected in parallel to form a single turn in the low voltage side, while an additional two layers (the layers of FIGS. 16C and 16F) are connected in series to form the ten turns in the high voltage side. FIGS. 16B-16G are drawn to scale for some embodiments, with the shorter edge of the printed circuit board having a length between 0.5 inches and three inches (e.g., a length of 1.5 inches). The printed circuit board illustrated in FIGS. 16B-16G may be used, e.g., with an E-E core, only the central limb of which is visible (as a rectangle) in the printed circuit board (the other limbs being outside the edges of the printed circuit board). This arrangement adopts an interleaved split winding configuration of (0.25P-5S-0.25P-0.25P-5S-0.25P) to evenly distribute the magnetomotive forces (mmf), thereby minimizing winding losses. Moreover, to minimize the inter-winding capacitance effect, shielding layers can be included between the primary and secondary layers. The transformer incorporates a 1.2 mm air gap to achieve the requisite magnetizing inductance (Lm), as determined in the earlier section. Both the transformer and inductor cores are ferrite materials to accommodate the high switching frequencies, with a design optimization that ensures compliance with converter specifications and minimal core losses. Heatsinks may be unnecessary in this converter design due to manageable heat flux (below 3 W/mm²) that results in a temperature elevation of 30° C. for a forced airflow of 200 linear feet per minute (LFM).

### B. Measurement of Transformer Parasitic Components

A vector network analyzer was utilized to accurately measure the parasitic components of a transformer. Winding resistances

$$( {R}_{p} , {R}_{s}^{′} )$$

were determined via impedance analysis with frequency sweeping. Leakage

$$( {L}_{p} , {L}_{s}^{′} )$$

and magnetizing inductances (Lₘ), along with intra-winding

$$( {C}_{p} , {C}_{s}^{′} )$$

and inter-winning (Cₚₛ) capacitances, were quantified using vector network analyzer under open and short circuit conditions, respectively. The values of these parasitic components are presented in Table V (FIG. 15C). The table reveals that the intra and inter-winding capacitance values are notably higher in this design compared to some transformer models. This difference can be attributed to the interleaved architecture employed in the current design.

As used herein, “a portion of” something means “at least some of” the thing, and as such may mean less than all of, or all of, the thing. As such, “a portion of” a thing includes the entire thing as a special case, i.e., the entire thing is an example of a portion of the thing. As used herein, when a second quantity is “within Y” of a first quantity X, it means that the second quantity is at least X-Y and the second quantity is at most X+Y. As used herein, when a second number is “within Y %” of a first number, it means that the second number is at least (1−Y/100) times the first number and the second number is at most (1+Y/100) times the first number. As used herein, the word “or” is inclusive, so that, for example, “A or B” means any one of (i) A, (ii) B, and (iii) A and B.

As used herein, when a method (e.g., an adjustment) or a first quantity (e.g., a first variable) is referred to as being “based on” a second quantity (e.g., a second variable) it means that the second quantity is an input to the method or influences the first quantity, e.g., the second quantity may be an input (e.g., the only input, or one of several inputs) to a function that calculates the first quantity, or the first quantity may be equal to the second quantity, or the first quantity may be the same as (e.g., stored at the same location or locations in memory as) the second quantity.

The terminology used herein is for the purpose of describing particular embodiments only and is not intended to be limiting of the inventive concept. As used herein, the terms “substantially,” “about,” and similar terms are used as terms of approximation and not as terms of degree, and are intended to account for the inherent deviations in measured or calculated values that would be recognized by those of ordinary skill in the art.

Any numerical range recited herein is intended to include all sub-ranges of the same numerical precision subsumed within the recited range. For example, a range of “1.0 to 10.0” or “between 1.0 and 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Similarly, a range described as “within 35% of 10” is intended to include all subranges between (and including) the recited minimum value of 6.5 (i.e., (1-35/100) times 10) and the recited maximum value of 13.5 (i.e., (1+35/100) times 10), that is, having a minimum value equal to or greater than 6.5 and a maximum value equal to or less than 13.5, such as, for example, 7.4 to 10.6. Any maximum numerical limitation recited herein is intended to include all lower numerical limitations subsumed therein and any minimum numerical limitation recited in this specification is intended to include all higher numerical limitations subsumed therein.

It will be understood that when an element is referred to as being “directly connected” or “directly coupled” to another element, there are no intervening elements present. As used herein, “generally connected” means connected by an electrical path that may contain arbitrary intervening elements, including intervening elements the presence of which qualitatively changes the behavior of the circuit. As used herein, “connected” means (i) “directly connected” or (ii) connected with intervening elements, the intervening elements being ones (e.g., low-value resistors or inductors, or short sections of transmission line) that do not qualitatively affect the behavior of the circuit.

Although exemplary embodiments of a power converter have been specifically described and illustrated herein, many modifications and variations will be apparent to those skilled in the art. Accordingly, it is to be understood that a power converter constructed according to principles of this disclosure may be embodied other than as specifically described herein. The invention is also defined in the following claims, and equivalents thereof.

What is claimed is:

1. A system, comprising:
a low-voltage switching circuit comprising a first port of the system;
a transformer, having:
a first winding connected to the low-voltage switching circuit, and
a second winding; and
a high-voltage switching circuit comprising a second port of the system and being connected to the second winding,
wherein:
the system is capable, for a first set of control parameter values, of transmitting power from the first port to the second port, with an efficiency of at least 90%, the first port being at a first voltage and the second port being at a voltage at least 50 times the first voltage; and
the system is capable, for a second set of control parameter values, of transmitting power from the second port to the first port, with an efficiency of at least 90%, the first port being at a first voltage and the second port being at a voltage between 85 times the first voltage and 144 times the first voltage.

2. The system of claim 1, wherein the low-voltage switching circuit comprises a circuit selected from the group consisting of half-bridge circuits and full-bridge circuits.

3. The system of claim 1, wherein the high-voltage switching circuit comprises a circuit selected from the group consisting of half-bridge circuits, center-tapped circuits, and full-bridge circuits.

4. The system of claim 1, comprising an inductance-capacitance tank circuit comprising a resonant capacitor on a first side of the transformer, and a resonant inductor on a second side of the transformer, the second side being different from the first side.

5. The system of claim 4, wherein the resonant capacitor is on a low-voltage side of the transformer, and the resonant inductor is on a high-voltage side of the transformer.

6. The system of claim 1, wherein the system is capable of achieving a transmitted power density of at least 5 W per cubic inch.

7. The system of claim 1, wherein the transformer is a high frequency planar transformer formed on a multi-layer printed circuit board, wherein:
a first layer of the multi-layer printed circuit board comprises a turn of the second winding;
a second layer of the multi-layer printed circuit board comprises a turn of the first winding;
a third layer of the multi-layer printed circuit board comprises a turn of the second winding; and
the second layer is between the first layer and the third layer.

8. The system of claim 1, wherein the second winding comprises at least eight times as many turns as the first winding.

9. The system of claim 1, wherein a switch of the low-voltage switching circuit comprises two semiconductor switches connected in parallel.

10. The system of claim 1, further comprising a switching control circuit configured:
to cause a first switch, of the low-voltage switching circuit, to turn on when a voltage across the first switch is less than 1% of an off state blocking voltage; and
to cause a second switch, of the high-voltage switching circuit, to turn on when a voltage across the second switch is less than 1% of an off state blocking voltage.

11. The system of claim 1, wherein the system is configured to operate over a range of switching frequencies extending from less than 350 kHz to more than 500 kHz.

12. A system, comprising:
a low-voltage switching circuit comprising a first port of the system;
a transformer, having:
a first winding connected to the low-voltage switching circuit, and
a second winding;
a high-voltage switching circuit comprising a second port of the system and being connected to the second winding; and
an inductance-capacitance tank circuit comprising a resonant capacitor on a first side of the transformer, and a resonant inductor on a second side of the transformer, the second side being different from the first side.

13. The system of claim 12, wherein the resonant capacitor is on a low-voltage side of the transformer, and the resonant inductor is on a high-voltage side of the transformer.

14. The system of claim 12, wherein the low-voltage switching circuit comprises a circuit selected from the group consisting of half-bridge circuits and full-bridge circuits.

15. The system of claim 12, wherein the high-voltage switching circuit comprises a circuit selected from the group consisting of half-bridge circuits, center-tapped circuits, and full-bridge circuits.

16. The system of claim 12, wherein the system is capable of achieving a transmitted power density of at least 5 W per cubic inch.

17. The system of claim 12, wherein the transformer is a high frequency planar transformer formed on a multi-layer printed circuit board, wherein:
a first layer of the multi-layer printed circuit board comprises a turn of the second winding;
a second layer of the multi-layer printed circuit board comprises a turn of the first winding;
a third layer of the multi-layer printed circuit board comprises a turn of the second winding; and
the second layer is between the first layer and the third layer.

18. The system of claim 12, wherein the second winding comprises at least eight times as many turns as the first winding.

19. A method, comprising:
selecting a circuit parameter or control parameter for a dc-to-dc converter, the selecting comprising:
calculating an operating current or an operating voltage for the dc-to-dc converter using an enhanced generalized harmonic approximation analysis.

20. The method of claim 19, wherein:
the dc-to-dc converter comprises:
a low-voltage switching circuit comprising a first port of the dc-to-dc converter;
a transformer, having:
a first winding connected to the low-voltage switching circuit, and
a second winding;
a high-voltage switching circuit comprising a second port of the dc-to-dc converter and being connected to the second winding; and
an inductance-capacitance tank circuit comprising a resonant capacitor on a first side of the transformer, and a resonant inductor on a second side of the transformer;
the method comprises selecting a circuit parameter for the dc-to-dc converter;
the circuit parameter is a parameter selected from the group consisting of the capacitance of the resonant capacitance, the inductance of the resonant inductor, the inductance of a magnetizing inductance of the transformer, the number of turns of the first winding, and the number of turns of the second winding;
the selecting comprises optimizing an objective function subject to a constraint;
the objective function is based on an efficiency of the dc-to-dc converter; and
the constraint constrains the dc-to-dc converter to operate with zero-voltage switching.
